(19) United States
(12) Patent Application Publication
(10) Pub. No.: US 2010/0250186 A1
(43) Pub. Date: Sep. 30, 2010

(54) SYSTEM FOR MEASURING THICKNESS OF MAILPIECES

(75) Inventors: Richard F. STENGL, Watertown, CT (US); John E. Richter, Trumbull, CT (US); Gerald F. Leitz, New Milford, CT (US); John W. Sussmeier, Cold Spring, NY (US); Padmaja Maganti, Waterbury, CT (US)

Correspondence Address: PITNEY BOWES INC.;INTELLECTUAL PROPERTY & TECH. LAW DEPT., 35 WATERVIEW DRIVE, MSC 26-22, SHELTON, CT, 06484, US

(73) Assignee: Pitney Bowes Inc., Stamford, CT (US)

(21) Appl. No.: 12/642,886

(22) Filed: Dec. 21, 2009

Related U.S. Application Data
(60) Provisional application No. 61/165,461, filed on Mar. 31, 2009.

(51) Int. Cl. G01B 5/06

(52) U.S. Cl. 702/170

(57) ABSTRACT

A method of measuring a thickness of mailpieces includes calculating, for each mailpiece comprising a unique collation, an estimated mailpiece thickness value, including combining a measured envelope thickness value, a measured insert thickness value for each insert associated with the mailpiece, and a theoretical document thickness value for an input document associated with the mailpiece. The method further includes assembling the mailpiece, obtaining a measured mailpiece thickness value for the mailpiece, and comparing the measured mailpiece thickness value with the estimated mailpiece thickness value. The method further includes, where the measured mailpiece thickness value is within a predetermined tolerance of the estimated mailpiece thickness value, storing the measured mailpiece thickness value as a reference thickness value in a database on a processing device, and where the measured mailpiece thickness value is outside of a predetermined tolerance of the estimated mailpiece thickness value, outsorting the mailpiece.

### CROSS REFERENCE TO RELATED APPLICATIONS

The benefit of priority is claimed under 35 U.S.C. 119(e) of U.S. Provisional Patent Application No. 61/165,461 filed Mar. 31, 2009, entitled “Control of Thickness Calibration,” which is incorporated by reference herein in its entirety.

### FIELD OF THE INVENTION

The present invention relates to a thickness measurement system and, more particularly, to a method and device for measuring thickness of mailpieces.

### BACKGROUND OF THE INVENTION

Inserter machines are used to create mailpieces for many different applications. Inserters contain a generally modular array of components to carry out the various processes associated with mailpiece creation. The processes include preparing documents, assembling the documents associated with a given mailpiece, adding any designated inserts, stuffing the assembly into an envelope, and printing information on the envelope.

Inserter machines create mailpieces based on a data file that contains information regarding the individual mailpieces, or based on information read directly from a code on the documents of the mailpieces. In both arrangements, the inserter is instructed to create mailpieces having specific content pages and insert materials (or no insert materials), among other features.

Occasionally, processing errors occur in inserter machines that result in mailpiece errors, such as incorrect content pages and/or inserts. In one example, a mailpiece may include one or more fewer or additional content pages than intended. Such errors may be particularly significant where the content relates to private information, such as financial or health related information, for example. Accordingly, it may be desirable to verify that the mailpieces created by an inserter machine actually contain the intended contents.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In accordance with the purpose of the invention, as embodied and broadly described herein, one aspect of the invention relates to a method of measuring a thickness of mailpieces comprising obtaining a measured envelope thickness value for envelopes associated with the mailpieces, obtaining a measured insert thickness value for each of a set of inserts associated with the mailpieces, and obtaining a theoretical document thickness value for input documents associated with the mailpieces.

The method may further comprise, for each mailpiece comprising a unique collation, calculating an estimated mailpiece thickness value by combining the measured envelope thickness value, the measured insert thickness value for each insert associated with the mailpiece, and the theoretical document thickness value for an input document associated with the mailpiece.

As used herein, “collation” means the contents of an envelope, including, for example, an input document and one or more inserts. Further, as used herein, “input document” means a document containing content intended for a recipient. Examples of input documents are, without limitation, bills, financial statements, medical statements, and letters.

According to an embodiment, the method further comprises assembling the mailpiece, obtaining a measured mailpiece thickness value for the mailpiece, and comparing the measured mailpiece thickness value with the estimated mailpiece thickness value. Assembling the mailpiece may comprise inserting the input document and each insert associated with the mailpiece into an envelope.

In some embodiments, the method further comprises, where the measured mailpiece thickness value is within a predetermined tolerance of the estimated mailpiece thickness value, storing the measured mailpiece thickness value as a reference thickness value in a database on a processing device. The method may further comprise, where the measured mailpiece thickness value is outside of a predetermined tolerance of the estimated mailpiece thickness value, outsorting the mailpiece.

As used herein, “outsorting” means diverting the mailpiece from a processing path. Outsorted mailpieces are typically diverted to a bin or other receptacle.

In another aspect, the invention relates to a method of measuring a thickness of mailpieces comprising calculating, for each mailpiece comprising a unique collation, an estimated mailpiece thickness value, comprising combining a measured envelope thickness value, a measured insert thickness value for each insert associated with the mailpiece, and a theoretical document thickness value for an input document associated with the mailpiece.

The method may further comprise assembling the mailpiece, obtaining a measured mailpiece thickness value for the mailpiece, and comparing the measured mailpiece thickness value with the estimated mailpiece thickness value.

According to an embodiment, the method further comprises, where the measured mailpiece thickness value is within a predetermined tolerance of the estimated mailpiece thickness value, storing the measured mailpiece thickness value as a reference thickness value in a database on a processing device, and, where the measured mailpiece thickness value is outside of a predetermined tolerance of the estimated mailpiece thickness value, outsorting the mailpiece.

In a further aspect, the invention provides a device for measuring a thickness of mailpieces comprising an inserter system for assembling the mailpieces, wherein assembling the mailpieces comprises inserting each insert associated with a respective mailpiece into an envelope and inserting an input document associated with the respective mailpiece into the envelope.

In one embodiment, the device further comprises a thickness measurement device for obtaining a measured envelope thickness value for envelopes associated with the mailpieces, a measured insert thickness value for each of a set of inserts associated with the mailpieces, and a measured mailpiece thickness value for the assembled mailpieces, and a processing device configured to calculate, for each mailpiece comprising a unique collation, an estimated mailpiece thickness value by combining the measured envelope thickness value, the measured insert thickness value for each insert associated with the mailpiece, and a theoretical document thickness value for an input document associated with the mailpiece, and compare the measured mailpiece thickness value with the estimated mailpiece thickness value.

In a further embodiment, the processing device is further configured to store the measured mailpiece thickness value as a reference thickness value in a database on the processing device, where the measured mailpiece thickness value is within a predetermined tolerance of the estimated mailpiece thickness value, and outsort the mailpiece, where the measured mailpiece thickness value is outside of a predetermined tolerance of the estimated mailpiece thickness value.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the drawings,

FIG. 1 is a schematic view of an inserter system for implementing an embodiment of the method of the present invention;

FIG. 2 is a partially schematic view of an embodiment of the thickness measurement system according to the invention;

FIG. 3 is a partially schematic view of the thickness measurement system of FIG. 2;

FIG. 4 is a side view of a portion of the thickness measurement system of FIG. 2 in which the probe is withdrawn from the reference surface;

FIG. 5 is a side view similar to FIG. 4 in which the probe is engaged with a mailpiece on the reference surface; and

FIG. 6 is an example of an error correction value applied to certain mailpieces.

### DETAILED DESCRIPTION OF EXEMPLARY EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Embodiments of the method and device for measuring thickness of mailpieces according the invention will be described with reference to certain applications in mailpiece inserter systems. It should be understood, however, that embodiments of the invention may be used in association with other systems configured to handle and transport mailpieces.

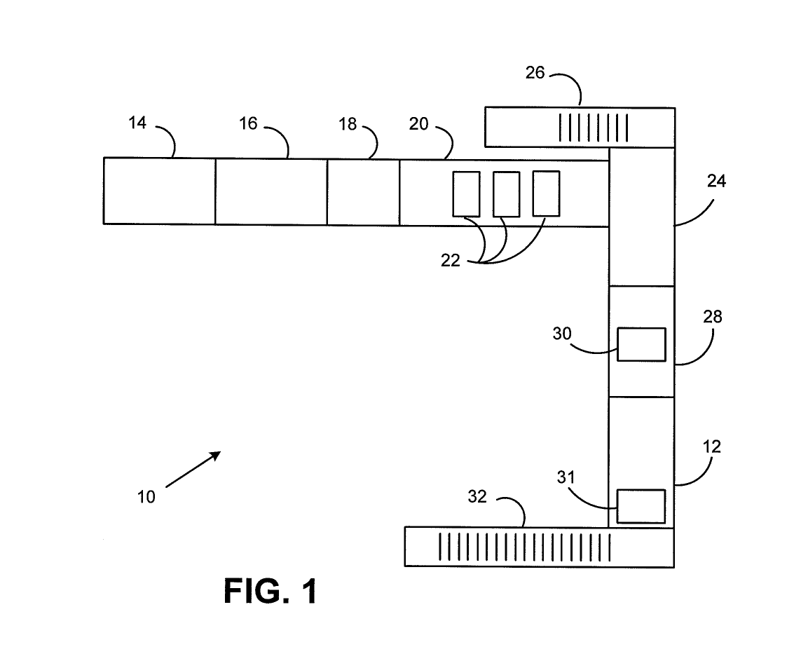

A schematic view of an inserter system 10 incorporating the thickness measurement device 12 of the invention is shown in FIG. 1. The illustrated exemplary inserter system 10 comprises a document feeder 14, which provides pre-printed documents for processing. The documents, which may comprise bills or financial statements, for example, may be provided by the document feeder 14 as individual “cut sheets,” or may be cut from a spool using a web cutter (not shown).

The documents next move to an accumulator 16, where the documents for respective mailpieces are assembled and folded. The folded accumulations next move to a buffer 18, which holds the accumulations for sequential processing. The accumulations next move to a chassis 20. As each accumulation moves through the chassis, inserts from a plurality of feeder modules 22 are added to the accumulation.

The accumulations next enter an insertion area 24, where the finished accumulations are stuffed into envelopes provided by an envelope hopper 26, and the envelopes are sealed. The stuffed, sealed envelopes then enter a printing area 28, where markings, such as a postage indicia and/or address information, for example, are applied using a printer 30 to form completed mailpieces.

The mailpieces next pass through the thickness measurement device 12 of the invention, as discussed in more detail below. The illustrated inserter system 10 includes an outsort module 31, downstream of the thickness measurement device 12, for optionally diverting mailpieces, such as defective mailpieces, for example, from the production stream. Finally, the completed mailpieces are deposited on a conveyor 32. Other systems utilizing more or fewer components and/or different arrangements of components may also be used.

The thickness measurement device 12 used in accordance with the present invention may allow a user to verify that a mailpiece containing a particular collation, including an input document and one or more inserts, for example, has a measured thickness that corresponds to a reference thickness for that collation. In some embodiments, the thickness measurement device 12 is configured to measure items to an accuracy of approximately 0.4 mils (0.0004 inches), which roughly corresponds to 1/10 of the thickness of a sheet of paper. Systems having other measurement ranges may also be used. Accordingly, the invention may provide improved integrity in a mailpiece production system.

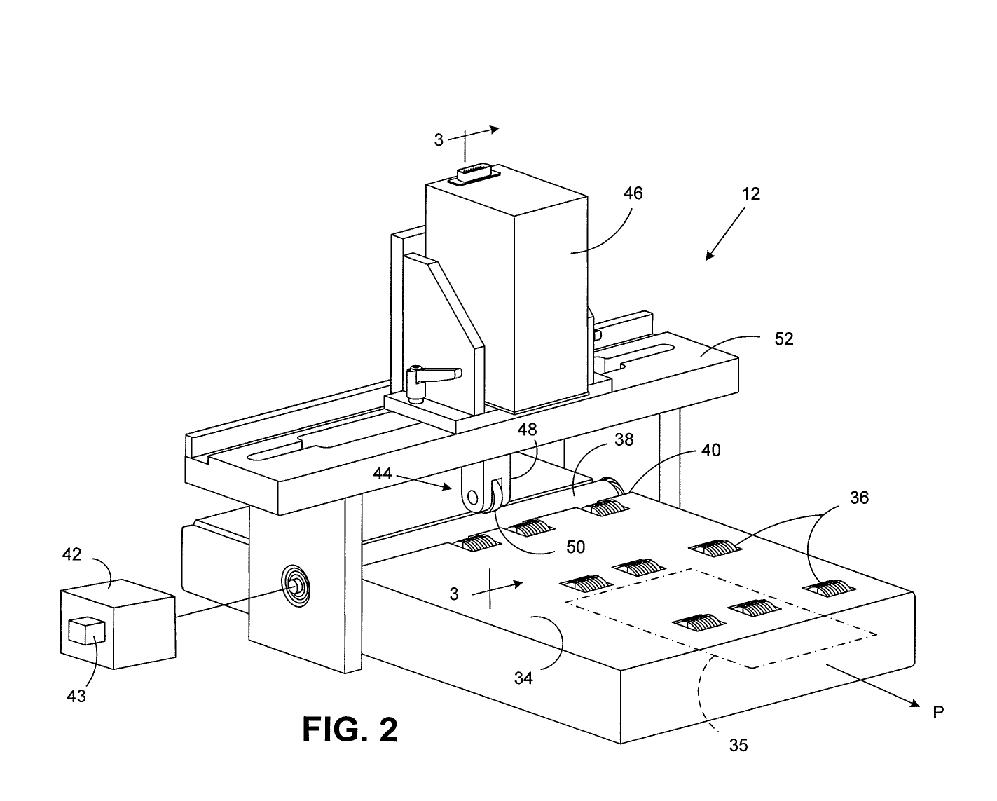

An embodiment of a thickness measurement device 12 suitable for use with the invention is shown in FIG. 2. The system in the illustrated embodiment comprises a transport deck 34 for slidably supporting mailpieces 35 that are conveyed on a transport path P, which is indicated with an arrow.

The mailpieces 35 are conveyed along the deck 34 using transport elements 36. The transport elements 36 convey the mailpieces 35 at a selected transport speed. In the illustrated embodiment, the transport elements 36 comprise a plurality of driven rollers. In some embodiments, nip rollers (not shown) may be arranged to engage the driven rollers to provide positive control over the mailpieces 35 being conveyed. In other embodiments, the transport elements 36 may comprise one or more belts, O-rings, or chains, for example. Other arrangements may also be used.

The illustrated device 12 further comprises a substantially cylindrical reference surface 38 disposed in the transport path P. As shown in FIG. 2, the reference surface 38, which protrudes slightly from an opening 40 in the deck 34, is arranged to contact the mailpieces 35 being conveyed on the transport path P. In one embodiment, the reference surface 38 comprises a roller having a diameter of approximately 1.25 inches and a width of approximately 10 inches in order to accommodate mailpieces of varying sizes. The reference surface 38 may comprise hardened steel due to its dimensional stability. Other sizes and materials may also be used.

The reference surface 38 is rotated approximately at the transport speed by a first actuator 42 provided with a first positional encoder 43 to track the position of the reference surface 38. In one embodiment, the first actuator 42 comprises a servo motor and the first positional encoder 43 comprises a rotary encoder. Other arrangements may also be used.

The system shown in FIG. 2 further comprises a probe 44 that is extendable to engage the mailpieces 35 on the reference surface 38, and retractable to withdraw from the reference surface 38 and the mailpieces 35, as described below. The probe 44 is driven by a second actuator 46 provided with a second positional encoder 47 to track a position of the probe 44. In the illustrated embodiment, the second actuator 46 comprises a servo motor and the second positional encoder 47 comprises a linear encoder. Other arrangements may also be used.

As show in FIGS. 2-5, the probe 44 comprises a support element 48 operatively connected to the second actuator 46 and a rotatably mounted probe tip 50 disposed on the support element 48. In the illustrated embodiment, the probe tip 50 comprises a roller mounted on a clevis arrangement. Other arrangements may also be used. The probe tip 50, which comprises hardened steel in some embodiments, is substantially aligned with the transport path P and is configured to contact the mailpieces 35 on the reference surface 38 in rolling engagement. Other materials may also be used.

As shown in FIG. 2, the reference surface 38 and the second actuator 46 are disposed on a substantially rigid frame assembly 52, which minimizes relative motion between the reference surface 38 and the second actuator 46. In some embodiments, the second actuator 46 is selectively displaceable axially with respect to the reference surface 38, i.e., laterally of the transport path P. The displacement may allow the probe 44 to be positioned optimally for envelopes of various widths.

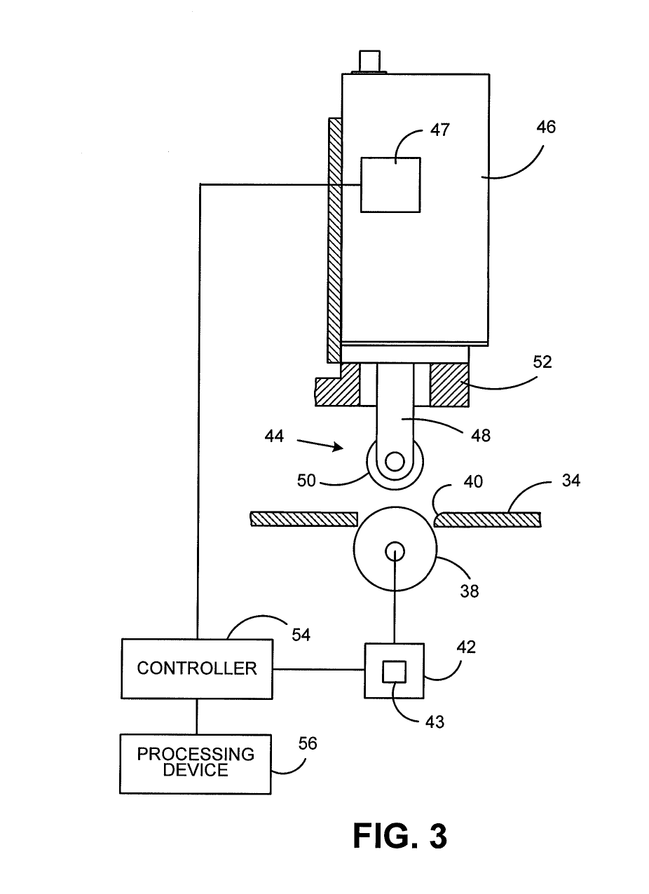

In the illustrated embodiment of the thickness measurement device 12, the rotation of the reference surface 38 and engagement of the probe 44 are controlled by a controller 54 operatively connected to a processing device 56, as shown in FIG. 3. In some embodiments, the controller 54 also controls the operation of the inserter system 10.

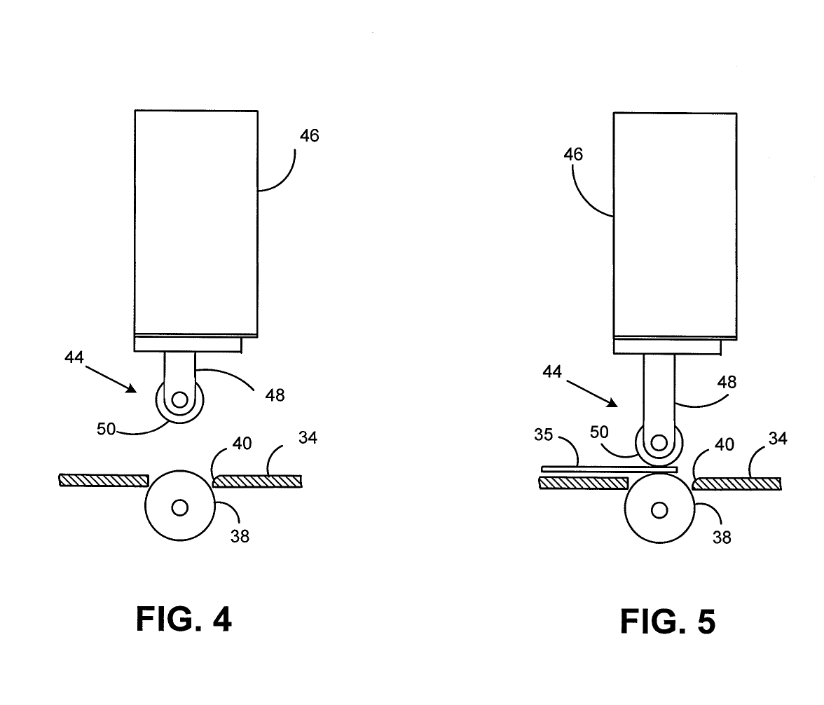

The operation of the thickness measurement device 12 is described briefly with reference to FIGS. 4 and 5. Initially, the probe 44 is withdrawn from the reference surface 38, as shown in FIG. 4, to accommodate an approaching mailpiece 35. In some embodiments, the full range of motion of the probe 44 between the extended and withdrawn positions is approximately 0.5 inches. Probe assemblies having other ranges may also be used.

Next, as the mailpiece 35 is passing over the reference surface 38, the probe 44 is lowered and placed into contact with the mailpiece 35. The second positional encoder 47 determines the position of the probe 44 with respect to the reference surface 38, i.e., the offset of the probe 44 from the reference surface 38. That offset corresponds to the thickness of the mailpiece 35. The measured thickness data may be stored in the processing device 56, as discussed below.

In one embodiment, measured thickness data, which is based on the output of the second positional encoder 47, is captured during the application of a constant force by the probe 44 on a predetermined contact zone on the mailpiece 35. The contact zone comprises a length that allows the second positional encoder 47 to settle to a stable thickness value so that an accurate thickness measurement can be made. For many mailpiece applications, the available distance for the contact zone is limited. It is desirable for the mailpiece 35 in this contact zone to have a substantially constant thickness and contain substantially no ridges or edges due to the contents, envelope flaps, windows, and/or side seams of the mailpiece 35.

The number of measurements obtained by the second positional encoder 47 is based on the speed of the mailpiece 35, the size of the contact zone, and the sampling rate of the servo associated with the probe 44. In one example, the mailpiece 35 is conveyed at 100 inches per second, the measurement contact zone is 0.5 inches long, and the sampling rate of the servo is 2 kHz. In that example, 10 measurements may be acquired in the contact zone. Other arrangements may also be used, including different conveying speeds, different sized contact zones, and servos having different sampling rates.

For a given mailing application, in order to have the probe tip 50 contact the contact zone precisely, the assembly, including the second actuator 46 and the probe 44, may be adjusted across the mailpiece flow path so that the probe tip 50 will contact the mailpiece 35 at the correct location on the mailpiece 35. In some embodiments, the contact zone is as long as the mailing application physically permits because a longer contact zone may provide more measurement data, resulting in a more accurate measured mailpiece thickness and higher integrity levels.

In a given mailpiece production run there are a range of different collations created, corresponding to input documents having different numbers of pages, as well as a varying number of inserts that accompany the input document. The thickness measurement device 12 used in accordance with the present invention may improve mailpiece integrity by allowing the measurement of the thickness of the mailpieces and the comparison of the measured thickness with a reference value for each collation. Thus, embodiments of the method and device of the invention may allow a user to verify that all of the pages of an input document are present and/or that all desired inserts have been included in a mailpiece, for example.

According to an embodiment of the invention, a method of measuring a thickness of mailpieces comprises obtaining a measured envelope thickness value for envelopes associated with the mailpieces, and obtaining a measured insert thickness value for each of a set of inserts associated with the mailpieces.

In one embodiment, obtaining a measured envelope thickness value for envelopes comprises passing an empty envelope through the thickness measurement device 12. A single envelope measurement may be obtained where all of the mailpieces in a production run will use the same size envelope made from paper having the same weight.

Further, in this embodiment, obtaining a measured insert thickness value for each of a set of inserts comprises inserting each insert into an envelope, passing the envelope containing the insert through the thickness measurement device to obtain a combined thickness value, and subtracting the measured envelope thickness value from the combined thickness value.

This embodiment of the method further comprises obtaining a theoretical document thickness value for input documents associated with the mailpieces. The theoretical document thickness value may be based on a weight of paper comprising the input document, a number of sheets of the input document, and a number of folds of the input document. Several standard paper weights and the associated theoretical sheet thicknesses are provided in the table below. Other values may also be used.

| Paper Weight | Sheet Thickness |
|---|---|
| (lbs./grams) | (mils) |
| 18/68 | 3.2 |
| 20/75 | 3.4 |
| 24/90 | 4.0 |

In one embodiment, the theoretical document thickness value is computed as the theoretical sheet thickness of the paper comprising the input document times the number of sheets in the input document times the number of sheet thicknesses resulting from folds of the input document. Thus, a tri-folded input document consisting of two sheets of 24 lb. paper would have a theoretical document thickness value of 4.0 mils*2 sheets*3 sheet thicknesses=24.0 mils.

The above values may be obtained in advance of a mail production run and those values may be combined, as described below, based on the contents of respective mailpiece collations. According to this embodiment, for each mailpiece comprising a unique collation, the method comprises calculating an estimated mailpiece thickness value by combining the measured envelope thickness value, the measured insert thickness value for each insert associated with the mailpiece, and the theoretical document thickness value for an input document associated with the mailpiece. Thus, the estimated mailpiece thickness value for each unique collation reflects the envelope thickness, the thickness of all the inserts in the collation, and the thickness of the pages of the input document.

The method further comprises assembling the mailpiece, comprising inserting the input document and each insert associated with the mailpiece into an envelope. Assembling the mailpiece may be carried out, for example, on the inserter system 10, shown in FIG. 1. Other mailpiece assembly systems may also be used.

According to an embodiment, the method further comprises obtaining a measured mailpiece thickness value for the mailpiece and comparing the measured mailpiece thickness value with the estimated mailpiece thickness value. In one embodiment, obtaining a measured mailpiece thickness value for the mailpiece 35 comprises passing the mailpiece 35 through the thickness measurement device 12. As discussed above, in that arrangement the measured mailpiece thickness value is obtained by contacting the mailpiece 35 on the contact zone with the probe 44 as the mailpiece 35 moves over the reference surface 38. In the illustrated embodiment, the measured mailpiece thickness value corresponds to the output of the second positional encoder 47, which determines the position of the probe with respect to the reference surface 38. Other thickness measurement systems may also be used.

In one embodiment, where the measured mailpiece thickness value is outside of a predetermined tolerance of the estimated mailpiece thickness value, the method comprises outsorting the mailpiece. The outsorted mailpiece may be diverted to a bin, for example, for later inspection. In a further embodiment, after a predetermined number of mailpieces containing a particular collation have been outsorted, the inserter system is stopped and the estimated mailpiece thickness value is modified to more closely approximate the measured mailpiece thickness values.

In another embodiment, where the measured mailpiece thickness value is within a predetermined tolerance of the estimated mailpiece thickness value, the method further comprises storing the measured mailpiece thickness value as a reference thickness value in a database on the processing device 56. Thus, where the measured mailpiece thickness value is within the predetermined tolerance of the estimated mailpiece thickness value, the measured value is considered to be a “good” value, and is saved. In one embodiment, the predetermined tolerance is approximately one-half the thickness of the minimum input document thickness. For example, in an application that has half-fold documents, the minimum input document thickness is approximately 8 mils and the predetermined tolerance would be approximately +/−4 mils. Other predetermined tolerance values may also be used.

The method further comprises, for subsequent mailpieces comprising like collations, obtaining a measured mailpiece thickness value for the subsequent mailpiece and comparing the measured mailpiece thickness value for the subsequent mailpiece with the reference thickness value. As discussed above, the reference thickness value in this case is the previously obtained measured mailpiece thickness value.

Where the measured mailpiece thickness value for the subsequent mailpiece (T_{MEAS}) is within a predetermined tolerance of the reference thickness value (T_{REF}), the method further comprises computing an average of the measured mailpiece thickness value for the subsequent mailpiece and the reference thickness value, and storing the computed average in the database as an updated reference thickness value (T_{REF/UPDATE}). The average may comprise a moving average, such as an exponential moving average, for example.

In one embodiment, an exponential moving average using the following equation is used:

T_{REF/UPDATE}=(1−α)*T_{REF}+α*T_{MEAS},
where: α=2/(M+1) and
   M=the number of samples in a sliding average window.

The exponential moving average gives greater weight to recent measurements and may allow the system to tolerate slight variations in measured thickness without incorrectly identifying the mailpiece as defective and outsorting it, as discussed below. Such variations may occur, for example, when new envelopes are added to the inserter during a production run that have a different thickness than the previous envelope supply. In addition, the exponential moving average may compensate for error introduced by the theoretical document thickness value.

Where the measured mailpiece thickness value for the subsequent mailpiece is outside of a predetermined tolerance of the reference thickness value, the method comprises outsorting the subsequent mailpiece. Again, the outsorted mailpiece may be diverted to a bin, for example, for later inspection. The measured mailpiece thickness values of the outsorted mailpieces are disregarded and are not averaged with the reference thickness value for the respective collations.

It has been observed that, for thicker collations, the thickness measurement device 12 provides a measured mailpiece thickness value that is thicker than the actual thickness of the mailpiece 35, due to the interaction of the probe tip 50 with the layers of paper in the collation. Accordingly, in a further embodiment, the method comprises, for mailpieces having a measured mailpiece thickness value greater than a predetermined thickness, adding an error correction value to the estimated mailpiece thickness value before comparing the measured mailpiece thickness value with the estimated mailpiece thickness value. Thus, the estimated mailpiece thickness value is inflated to approximate the known deviations in the measured mailpiece thickness value for respective higher mailpiece thicknesses. In one example, the error correction value is added to mailpieces having a measured mailpiece thickness value greater than approximately 50 mils.

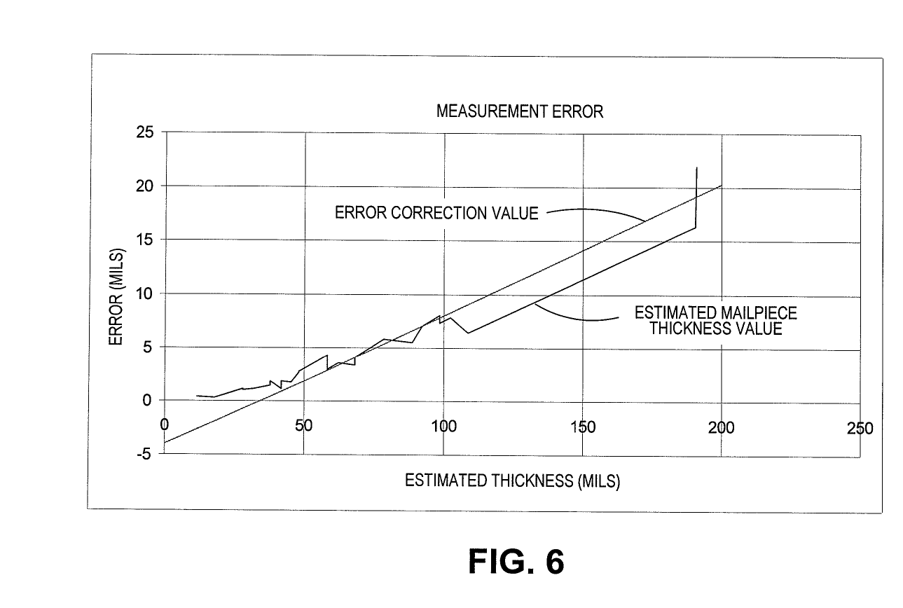

An example of an error correction is shown in FIG. 6 along with the estimated mailpiece thickness value for mailpieces in a production run. Other error corrections may also be used.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A method of measuring a thickness of mailpieces, comprising:
obtaining a measured envelope thickness value for envelopes associated with the mailpieces;
obtaining a measured insert thickness value for each of a set of inserts associated with the mailpieces;
obtaining a theoretical document thickness value for input documents associated with the mailpieces;
for each mailpiece comprising a unique collation, calculating an estimated mailpiece thickness value by combining the measured envelope thickness value, the measured insert thickness value for each insert associated with the mailpiece, and the theoretical document thickness value for an input document associated with the mailpiece;
assembling the mailpiece, comprising inserting the input document and each insert associated with the mailpiece into an envelope;
obtaining a measured mailpiece thickness value for the mailpiece; and
comparing the measured mailpiece thickness value with the estimated mailpiece thickness value.

2. The method of claim 1, wherein obtaining a measured envelope thickness value for envelopes comprises passing an empty envelope through a thickness measurement device.

3. The method of claim 2, wherein obtaining a measured insert thickness value for each of a set of inserts comprises:
inserting each insert into an envelope;
passing the envelope containing the insert through the thickness measurement device to obtain a combined thickness value; and
subtracting the measured envelope thickness value from the combined thickness value.

4. The method of claim 2, wherein obtaining a measured mailpiece thickness value for the mailpiece comprises passing the mailpiece through a thickness measurement device.

5. The method of claim 2, wherein the thickness measurement device comprises:
a reference surface disposed in a transport path;
a probe;
an actuator for moving the probe with respect to the reference surface; and
a sensor for determining a position of the probe with respect to the reference surface.

6. The method of claim 5, wherein obtaining a measured thickness value for an item comprises:
placing the item in contact with the reference surface;
moving the probe into contact with the item; and
determining the position of the probe with respect to the reference surface.

7. The method of claim 1, wherein the theoretical document thickness value is based on a weight of paper comprising the input document, a number of sheets of the input document, and a number of folds of the input document.

8. The method of claim 1, further comprising, where the measured mailpiece thickness value is within a predetermined tolerance of the estimated mailpiece thickness value, storing the measured mailpiece thickness value as a reference thickness value in a database on a processing device.

9. The method of claim 8, further comprising, for subsequent mailpieces comprising like collations:
obtaining a measured mailpiece thickness value for the subsequent mailpiece; and
comparing the measured mailpiece thickness value for the subsequent mailpiece with the reference thickness value.

10. The method of claim 9, further comprising, where the measured mailpiece thickness value for the subsequent mailpiece is within a predetermined tolerance of the reference thickness value:
computing an average of the measured mailpiece thickness value for the subsequent mailpiece and the reference thickness value; and
storing the computed average in the database as an updated reference thickness value.

11. The method of claim 10, wherein the average comprises a moving average.

12. The method of claim 9, further comprising, where the measured mailpiece thickness value for the subsequent mailpiece is outside of a predetermined tolerance of the reference thickness value, outsorting the subsequent mailpiece.

13. The method of claim 1, further comprising, where the measured mailpiece thickness value is outside of a predetermined tolerance of the estimated mailpiece thickness value, outsorting the mailpiece.

14. The method of claim 1, further comprising, for mailpieces having a measured mailpiece thickness value greater than a predetermined thickness, adding an error correction value to the estimated mailpiece thickness value before comparing the measured mailpiece thickness value with the estimated mailpiece thickness value.

15. A method of measuring a thickness of mailpieces, comprising:
calculating, for each mailpiece comprising a unique collation, an estimated mailpiece thickness value, comprising combining a measured envelope thickness value, a measured insert thickness value for each insert associated with the mailpiece, and a theoretical document thickness value for an input document associated with the mailpiece;
assembling the mailpiece;
obtaining a measured mailpiece thickness value for the mailpiece;
comparing the measured mailpiece thickness value with the estimated mailpiece thickness value;
where the measured mailpiece thickness value is within a predetermined tolerance of the estimated mailpiece thickness value, storing the measured mailpiece thickness value as a reference thickness value in a database on a processing device; and
where the measured mailpiece thickness value is outside of a predetermined tolerance of the estimated mailpiece thickness value, outsorting the mailpiece.

16. The method of claim 15, further comprising, for subsequent mailpieces comprising like collations:
obtaining a measured mailpiece thickness value for the subsequent mailpiece; and
comparing the measured mailpiece thickness value for the subsequent mailpiece with the reference thickness value.

17. The method of claim 16, further comprising:
where the measured mailpiece thickness value for the subsequent mailpiece is within a predetermined tolerance of the reference thickness value,
computing an average of the measured mailpiece thickness value for the subsequent mailpiece and the reference thickness value; and
storing the computed average in the database as an updated reference thickness value; and
where the measured mailpiece thickness value for the subsequent mailpiece is outside of a predetermined tolerance of the reference thickness value, outsorting the subsequent mailpiece.

18. The method of claim 17, wherein the average comprises a moving average.

19. A device for measuring a thickness of mailpieces, comprising:
an inserter system for assembling the mailpieces, wherein assembling the mailpieces comprises:
inserting each insert associated with a respective mailpiece into an envelope; and
inserting an input document associated with the respective mailpiece into the envelope;
a thickness measurement device for obtaining a measured envelope thickness value for envelopes associated with the mailpieces, a measured insert thickness value for each of a set of inserts associated with the mailpieces, and a measured mailpiece thickness value for the assembled mailpieces; and
a processing device configured to:
calculate, for each mailpiece comprising a unique collation, an estimated mailpiece thickness value by combining the measured envelope thickness value, the measured insert thickness value for each insert associated with the mailpiece, and a theoretical document thickness value for an input document associated with the mailpiece; and
compare the measured mailpiece thickness value with the estimated mailpiece thickness value.

20. The device of claim 19, wherein the processing device is further configured to:
store the measured mailpiece thickness value as a reference thickness value in a database on the processing device, where the measured mailpiece thickness value is within a predetermined tolerance of the estimated mailpiece thickness value; and
outsort the mailpiece, where the measured mailpiece thickness value is outside of a predetermined tolerance of the estimated mailpiece thickness value.
